(19) United States
(12) Patent Application Publication
(10) Pub. No.: US 2026/0233304 A1
(43) Pub. Date: Aug. 13, 2026

(54) SINTERED MATERIAL, METHOD FOR PRODUCING SAME, AND ELECTRON SOURCE AND DEVICE PROVIDED WITH SAME

(71) Applicants: Denka Company Limited, Tokyo (JP); NATIONAL INSTITUTE OF ADVANCED INDUSTRIAL SCIENCE AND TECHNOLOGY, Tokyo (JP)

(72) Inventors: Hiromitsu CHATANI, Tokyo (JP); Daisuke SATOH, Ibaraki (JP); Masahito TANAKA, Ibaraki (JP); Hiroshi OGAWA, Ibaraki (JP)

(21) Appl. No.: 19/469,353

(22) PCT Filed: Mar. 27, 2024
(86) PCT No.: PCT/JP2024/012476

§ 371 Date: Sep. 25, 2025

(30) Foreign Application Priority Data
Mar. 29, 2023 (JP) 2023-053787

(51) Int. Cl. B22F 3/10

(52) U.S. Cl. CPC B22F 3/1007; B22F 2301/25

(57) ABSTRACT

A method for producing a sintered material, the sintered material being constituted by iridium and cerium, and the method including: a step of preparing a sintered body constituted by iridium and cerium; and a step of heating the sintered body at a temperature of 1400 to 1800° C. for 0.5 hours or more in an atmosphere having an oxygen partial pressure of 10⁻¹ Pa or less to obtain the sintered material. A sintered material constituted by iridium and cerium, having a work function of 3.8 eV or less.

### TECHNICAL FIELD

The present disclosure relates to a sintered material, a method for producing the same, and an electron source and a device provided with the same.

### BACKGROUND ART

The emitter that emits electrons is used in, for example, an electron microscope and a semiconductor inspection device. The emitter includes an electron source and a heater that heats the electron source, and the heater is energized to heat the electron source, thereby obtaining emission current. The electron source is constituted by an electron emission material. Examples of the electron emission material include rare earth borides such as lanthanum boride (LaB₆) and cerium boride (CeB₆); and high melting point metals such as tungsten, tantalum, and hafnium, and oxides, carbides, and nitrides thereof. In recent years, it has been studied to use a sintered body constituted by iridium and cerium as an electron source (see Patent Literatures 1 and 2).

### CITATION LIST

### Patent Literature

Patent Literature 1: Japanese Patent No. 6285254

Patent Literature 2: Japanese Patent No. 6805306

### SUMMARY OF INVENTION

### Technical Problem

The present inventors evaluated the performance of a sintered body constituted by iridium and cerium as an electron source, and found that the sintered body has a large work function and has room for improvement in practical use as an electron source.

One aspect of the present disclosure has been made in view of the above problems, and an object of the present disclosure is to provide a sintered material constituted by iridium and cerium and having a sufficiently small work function, and a method for producing the same. As another aspect of the present disclosure, an object of the present disclosure is to provide an electron source constituted by the sintered material and a device provided with the same.

### Solution to Problem

One aspect of the present disclosure relates to a method for producing a sintered material constituted by iridium and cerium. The method for producing a sintered material includes: a step of preparing a sintered body constituted by iridium and cerium; and a step of heating the sintered body at a temperature of 1400 to 1800° C. for 0.5 hours or more in a low oxygen atmosphere to obtain the sintered material. In the present disclosure, the “sintered body” means a state before the heating, and the “sintered material” means a state after the heating.

In the method for producing the same, a sintered body constituted by iridium and cerium is heated under predetermined conditions, and thereby a sintered material having a sufficiently small work function can be obtained. For example, even when the sintered body has a work function of 4.1 to 4.3 eV, a sintered material having a work function of 3.8 eV or less can be obtained through the heating. The mechanism to obtain a small work function through heating is not completely clear, but the present inventors presume that this is mainly because the sintered body is crystalized by heating to form a crystal body, and metal iridium is precipitated on the surface of the crystal body, so that metal iridium is dispersed in an island manner on the surface of the sintered material, or a metal iridium layer is formed to cover the entire surface of the crystal body. The heating may be performed in such a low oxygen atmosphere that the oxidation reaction of iridium and cerium does not proceed (atmosphere having an oxygen partial pressure of 10⁻¹ Pa or less).

The sintered body may be constituted by at least one crystal phase selected from the group consisting of an Ir₂Ce crystal phase, an Ir₃Ce crystal phase, an Ir₇Ce₂ crystal phase, and an Ir₅Ce crystal phase. From the viewpoint that metal iridium is easily precipitated on the surface of the sintered material to form an iridium region, the sintered body preferably has an iridium-rich composition, specifically, the sintered body is preferably constituted by an Ir₇Ce₂ crystal phase or an Ir₅Ce crystal phase among the above crystal phases. Cerium may be contained in an amount of 12.7 to 26.7 parts by mass with respect to 100 parts by mass in total mass of the sintered material produced from these sintered bodies.

Another aspect of the present disclosure relates to a sintered material constituted by iridium and cerium, having a work function of 3.8 eV or less. In one aspect, the sintered material includes: a main body constituted by iridium and cerium; and an iridium region formed on the surface of the main body. As described above, the sintered material, having been heated, has been crystallized. The crystallization degree can be determined by X-ray diffraction method (hereinafter, referred to as XRD) analysis of the surface of the sintered material. That is, in a spectrum obtained by XRD analysis of the surface of the sintered material, the first peak positioned at a scattering angle 2θ of 47.6° may have a half-value width of 0.5 or less, and the second peak positioned at a scattering angle 2θ of 55.5° may have a half-value width of 0.5 or less.

Another aspect of the present disclosure relates to an electron source constituted by the sintered material. Another aspect of the present disclosure relates to a device provided with the electron source. Examples of the device provided with the electron source include an electron microscope, a semiconductor manufacturing device, an inspection device, and a processing device.

### Advantageous Effects of Invention

One aspect of the present disclosure provides a sintered material constituted by iridium and cerium and having a sufficiently small work function, and a method for producing the same. Another aspect of the present disclosure provides an electron source constituted by the sintered material and a device provided with the same.

### BRIEF DESCRIPTION OF DRAWINGS

FIG. 1 is a plan view schematically illustrating a state in which an electron source according to an embodiment of the present disclosure is fixed to a filament.

FIG. 2 is a scanning electron microscope (hereinafter, referred to as SEM) image of the surface of the sintered body according to Comparative Example 1.

FIG. 3 is a spectrum obtained by XRD analysis of the surface of the sintered body according to Comparative Example 1.

FIG. 4 is a SEM image of the surface of the sintered material according to Example 1.

FIG. 5 is a spectrum obtained by XRD analysis of the surface of the sintered material according to Example 1.

FIG. 6 is a SEM image of the surface of the sintered material according to Example 2.

FIG. 7 is a spectrum obtained by XRD analysis of the surface of the sintered material according to Example 2.

FIG. 8(a) and 8(b) are images showing the results of energy dispersive X-ray analysis (hereinafter, referred to as EDX) mapping of the surface of the sintered body according to Comparative Example 1.

FIG. 9(a) and 9(b) are images showing the results of EDX mapping analysis of the surface of the sintered material according to Example 1.

FIG. 10(a) and 10(b) are images showing the results of EDX mapping analysis of the surface of the sintered material according to Example 2.

FIG. 11(a) and 11(b) are images showing the results of electron backscatter diffraction method (hereinafter, referred to as EBSD) analysis of the surface of the sintered material according to Example 1.

FIG. 12(a) and 12(b) are images showing the results of EBSD analysis of the surface of the sintered material according to Example 2.

### DESCRIPTION OF EMBODIMENTS

Hereinafter, embodiments of the present disclosure will be described with reference to the drawings. Note that the present invention is not limited to the following embodiments.

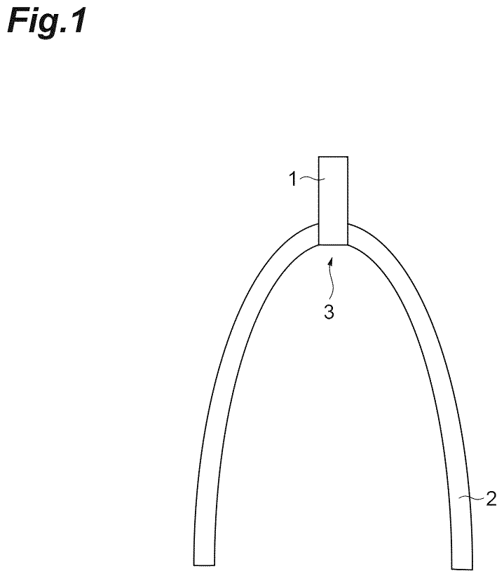

FIG. 1 is a plan view schematically illustrating a state in which an electron source according to the embodiment is fixed to a filament. An electron source 1 is a chip of a sintered material constituted by iridium and cerium. The electron source 1 is fixed to a filament 2 at a joint portion 3. The joint portion 3 is positioned at the top of the filament 2 bent in a loop shape. Examples of the device provided with the electron source 1 include an electron microscope, a semiconductor manufacturing device, an inspection device, and a processing device.

The electron source 1 is heated to emit electrons. The electron source 1 is heated by energizing the filament 2. The electron source 1 has a substantially rectangular parallelepiped shape. The tip of the electron source 1 may be machined into a conical shape or a quadrangular pyramid shape. The shape of the electron source 1 is not particularly limited, and the electron source 1 may be machined into a desired shape by electrical discharge machining or the like.

The filament 2 is energized to heat the electron source 1. The filament 2 may be, for example, a tungsten filament. The tungsten filament may contain an element other than tungsten (for example, rhenium, aluminum, silicon, and potassium) according to the required performance. The tungsten filament may be doped with an alkali metal (for example, potassium) for stabilization. When the tungsten filament contains rhenium, the rhenium content in the tungsten filament may be, for example, 2 to 30 mass %, 2 to 10 mass %, or 2 to 5 mass %. Rhenium has an effect of increasing the electrical resistivity of the tungsten filament.

As described above, the sintered material is constituted by iridium and cerium. The sintered material may contain at least one crystal phase selected from the group consisting of an Ir₂Ce crystal phase, an Ir₂Ce crystal phase, an Ir₇Ce₂ crystal phase, and an Ir₅Ce crystal phase.

The total content of iridium and cerium may be 97 parts by mass or more, 98 parts by mass or more, or 99 parts by mass or more, with respect to 100 parts by mass of the total mass of the sintered material. The sintered material may be made only of iridium, cerium, and unavoidable impurities.

Each of the iridium content and the cerium content is appropriately set according to the type of the crystal phase constituting the sintered material and the like. The iridium content may be 73.3 parts by mass or more, 77 parts by mass or more, or 80 parts by mass or more, and may be 87.3 parts by mass or less, 85 parts by mass or less, or 83 parts by mass or less, with respect to 100 parts by mass of the total mass of the sintered material. The cerium content may be 12.7 parts by mass or more, 15 parts by mass or more, or 17 parts by mass or more, and may be 26.7 parts by mass or less, 23 parts by mass or less, or 20 parts by mass or less, with respect to 100 parts by mass of the total mass of the sintered material.

The work function of the sintered material is 3.8 eV or less, preferably 3.7 eV or less, or 3.6 eV or less, or may be 3.4 eV or less, or 3.0 eV or less. When the work function is 3.8 eV or less, a sufficiently high current density can be achieved even when the sintered material (electron source 1) is used under low vacuum conditions (for example, 10⁻³ to 10⁻⁶ Pa). The lower limit of the work function of the sintered material may be, for example, 2.7 eV or more, 2.8 eV or more, 2.9 eV or more, 3.0 eV or more, 3.1 eV or more, 3.2 eV or more, or 3.3 eV or more.

In the present disclosure, the work function means a value measured by ultraviolet photoelectron spectroscopy (UPS method) under the following conditions.
Measurement sample: diameter 3 mm ×length 2.5 mm

### Heating Condition

Maximum heating temperature: 1550° C.
Integrated heating time: 78 hours (among them, the heating time at 1550° C. is 24 hours)

### Ultraviolet Photoelectron Spectroscopy Device

Photon energy of ultraviolet light: 21.22 eV
Bias voltage: −6 V
Measurement area: center
Energy resolution of photoelectron analyzer: 0.025 eV
Slot: 55 μm

### Ion Sputtering

As pretreatment for work function measurement, ion sputtering was performed under the following conditions in order to remove contamination on the outermost surface of the sample.
Ion species: argon ion
Acceleration voltage: 1 kV
Time: 20 to 100 seconds

The sintered material can be obtained by heating the sintered body constituted by iridium and cerium in a low oxygen atmosphere. That is, the method for producing a sintered material includes: a step of preparing a sintered body constituted by iridium and cerium; and a step of heating the sintered body at a temperature of 1400 to 1800° C. for 0.5 hours or more in a low oxygen atmosphere to obtain the sintered material. Herein, the low oxygen atmosphere means such an atmosphere that the oxidation reaction of iridium and cerium does not proceed. Specifically, the sintered body may be heated in a gas having an oxygen partial pressure of 10⁻¹ Pa or less, 10⁻² Pa or less, or 10⁻³ Pa or less, preferably 10⁻⁴ Pa or less, more preferably 10⁻⁵ Pa or less, still more preferably 5×10⁻⁵ Pa or less, 4×10⁻⁵ Pa or less, or 3×10⁻⁵ Pa or less. Such a low oxygen atmosphere can be achieved by using an inert gas atmosphere, or can be achieved by reducing the pressure to preferably 10⁻⁵ Pa or less, more preferably 10⁻⁶ Pa or less, in an air atmosphere.

The crystal phase constituting the sintered body may be at least one selected from the group consisting of an Ir₂Ce crystal phase, an Ir₃Ce crystal phase, an Ir₇Ce₂ crystal phase, and an Ir₃Ce crystal phase, and from the viewpoint that metal iridium is easily precipitated on the surface of the sintered material to form an iridium region, preferably at least one selected from the group consisting of an Ir₇Ce₂ crystal phase and an Ir₅Ce crystal phase.

The total content of iridium and cerium may be 97 parts by mass or more, 98 parts by mass or more, or 99 parts by mass or more with respect to 100 parts by mass of the total mass of the sintered body. The sintered body may be made only of iridium, cerium, and unavoidable impurities. Each of the iridium content and the cerium content is appropriately set according to the type of the crystal phase constituting the sintered body and the like. The iridium content may be 73.3 parts by mass or more, 77 parts by mass or more, or 80 parts by mass or more, and may be 87.3 parts by mass or less, 85 parts by mass or less, or 83 parts by mass or less, with respect to 100 parts by mass of the total mass of the sintered body. The cerium content may be 12.7 parts by mass or more, 15 parts by mass or more, or 17 parts by mass or more, and may be 26.7 parts by mass or less, 23 parts by mass or less, or 20 parts by mass or less, with respect to 100 parts by mass of the total mass of the sintered body.

In a spectrum obtained by XRD analysis (XRD spectrum) of the surface of the sintered body, a peak positioned at a scattering angle 2θ of 47.6° (first peak) and a peak positioned at a scattering angle 2θ of 55.5° (second peak) may be observed as peaks derived from Ir. In the spectrum, the half-value width of the first peak positioned at a scattering angle 2θ of 47.6° is larger than 0.5, or may be 0.5 or more, or 0.55 or more. The upper limit of the half-value width of the first peak may be, for example, 0.55 or less. In the spectrum, the half-value width of the second peak positioned at a scattering angle 2θ of 55.5° is larger than 0.5, or may be 0.6 or more, or 0.65 or more. The upper limit of the half-value width of the second peak may be, for example, 0.69. Such a sintered body can be obtained, for example, by sintering a powder constituted by iridium and cerium through a hot press method or a discharge plasma sintering method (see Patent Literatures 1 and 2).

As described above, the temperature at which the sintered body is heated is 1400 to 1800° C., preferably 1400 to 1600° C. or 1500 to 1800° C., and more preferably 1500 to 1600° C. When the temperature is 1400° C. or higher, an effect of promoting crystallization is exhibited, and when the temperature is 1800° C. or lower, an effect of suppressing dissolution of the material is exhibited.

As described above, the heating time is 0.5 hours or more, preferably 1 hour or more, 2 hours or more, or 2.5 hours or more, and may be 100 hours or more. When the heating time is 0.5 hours or more, an effect of promoting crystallization is exhibited, and when the heating time is 100 hours or more, an effect of precipitating iridium on the surface is more easily exhibited. The upper limit of the heating time may be, for example, 240 hours or less.

As described above, the work function of the sintered material after the heating is 3.8 eV or less, whereas the work function of the sintered body before the heating is, for example, 4.1 to 4.3 eV. The work function is reduced by heating presumably because the sintered body is crystalized to form a crystal body, and metal iridium is precipitated on the surface of the crystal body, so that metal iridium is dispersed in an island manner on the surface of the sintered material, or a metal iridium layer is formed to cover the entire surface of the crystal body.

The fact that crystallization proceeds by the heating as described above is confirmed by the half-value width of a peak derived from Ir in a XRD spectrum of the surface of each of the sintered body and sintered material before and after heating. Specifically, in an embodiment, the sintered body (before heating) shows, as described above, a peak positioned at a scattering angle 2θ of 47.6° and having a half-value width of larger than 0.5 (first peak) and a peak positioned at a scattering angle 2θ of 55.5° and having a half-value width of larger than 0.5 (second peak), whereas the sintered material (after heating) may show a peak positioned at a scattering angle 2θ of 47.6° and having a half-value width of 0.5 or less (first peak) and a peak positioned at a scattering angle 2θ of 55.5° and having a half-value width of 0.5 or less (second peak).

In a spectrum obtained by XRD analysis of the surface of the sintered material, the half-value width of the first peak positioned at a scattering angle 2θ of 47.6° is preferably 0.5 or less, more preferably 0.48 or less, 0.46 or less, 0.44 or less, 0.43 or less, or 0.42 or less, and may be 0,39 or more, 0.40 or more, or 0.41 or more. In a spectrum obtained by XRD analysis of the surface of the sintered material, the half-value width of the second peak positioned at a scattering angle 2θ of 55.5° is preferably 0.5 or less, more preferably 0.49 or less, and may be 0.43 or more, 0.44 or more, or 0.45 or more. When the first peak and the second peak have a half-value width of the upper limit or less, the sintered material easily achieves a sufficiently small work function value.

The state in which metal iridium is dispersed in an island manner on the surface of the sintered material can be observed by EDX (energy dispersive X-ray) mapping analysis of the surface of the sintered body or EBSD (electron back scatter diffraction) analysis of the surface of the sintered material. That is, from such observation, it can be seen that, in an embodiment, the sintered material may include: a main body constituting the core of the sintered material; and an iridium region formed on the surface of the main body.

The main body may be constituted by iridium and cerium. The iridium region may be a region constituted by iridium and may be a region not containing cerium. A plurality of iridium regions may be interspersed on the surface of the main body. The size of each iridium region (the maximum length of a straight line connecting two points on the outer periphery of one iridium region) may be, for example, 0.1 μm or more, 0.5 μm or more, or 1 μm or more, and may be 30 μm or less, 20 μm or less, or 10 μm or less.

### EXAMPLES

Hereinafter, the present invention will be described more specifically based on Examples, but the present invention is not limited to the following Examples.

### Comparative Example 1

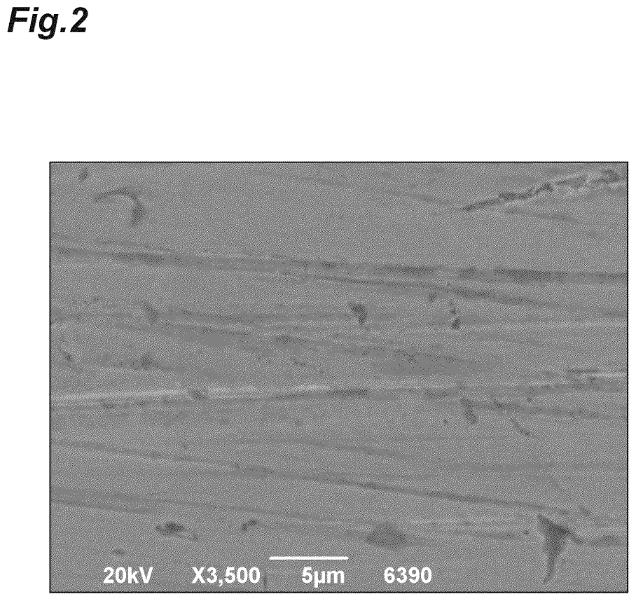

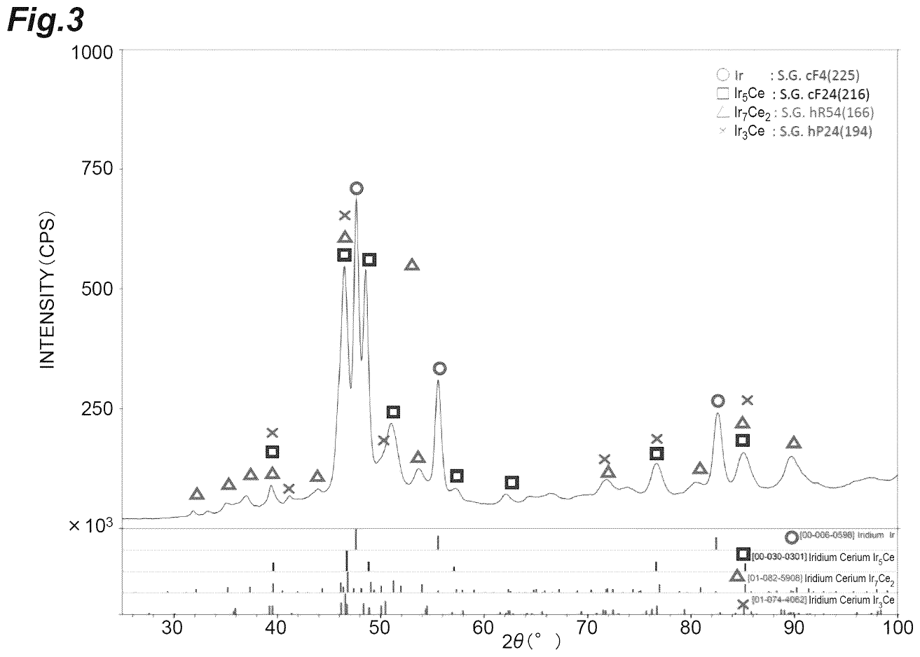

A sintered body containing Ir₇Ce₂ as the main crystal phase and also containing an Ir₃Ce crystal phase and an Ir₂Ce crystal phase (manufactured by KOBELCO research institute) was used as it was. FIG. 2 is a SEM image of the surface of the sintered body. FIG. 3 is an XRD spectrum of the surface of the sintered body. In the XRD spectrum, ○ represents a peak derived from Ir, □ represents a peak derived from Ir₅Ce, Δ represents a peak derived from Ir₇Ce₂, and x represents a peak derived from Ir₃Ce (hereinafter, the same applies). The first peak positioned at a scattering angle 2θ of 47.6° had a half-value width of 0.543, and the second peak positioned at a scattering angle 2θ of 55.5° had a half-value width of 0.690. In Comparative Example 1 and the following Examples, the XRD spectrum was obtained using an XRD apparatus manufactured by Rigaku Corporation, and the half-value width was determined using XRD analysis software (JADE, manufactured by MDI). Specifically, after the background was removed from the XRD spectrum, the first peak and the second peak were separated by peak fitting, and the half-value width of each peak was determined using the peaks. Kα2 was not removed.

The work function of the sintered body was 4.27 eV. In Comparative Example 1 and the following Examples, the work function was measured using an ultraviolet photoelectron spectrometer manufactured by Kratos analytical.

### Example 1

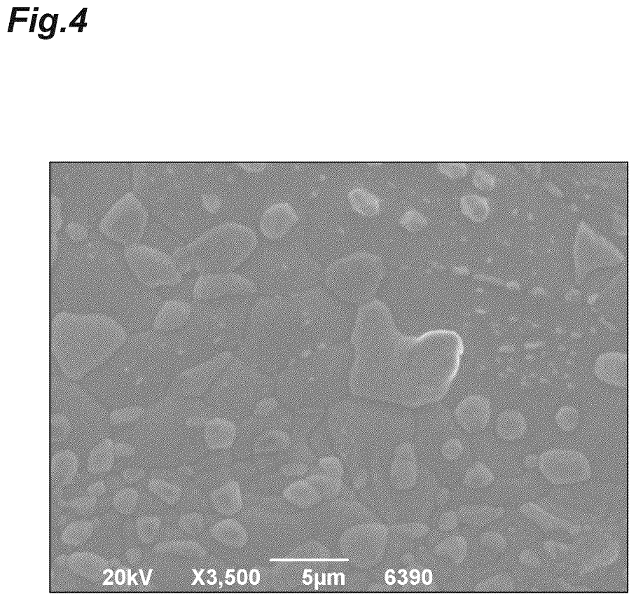

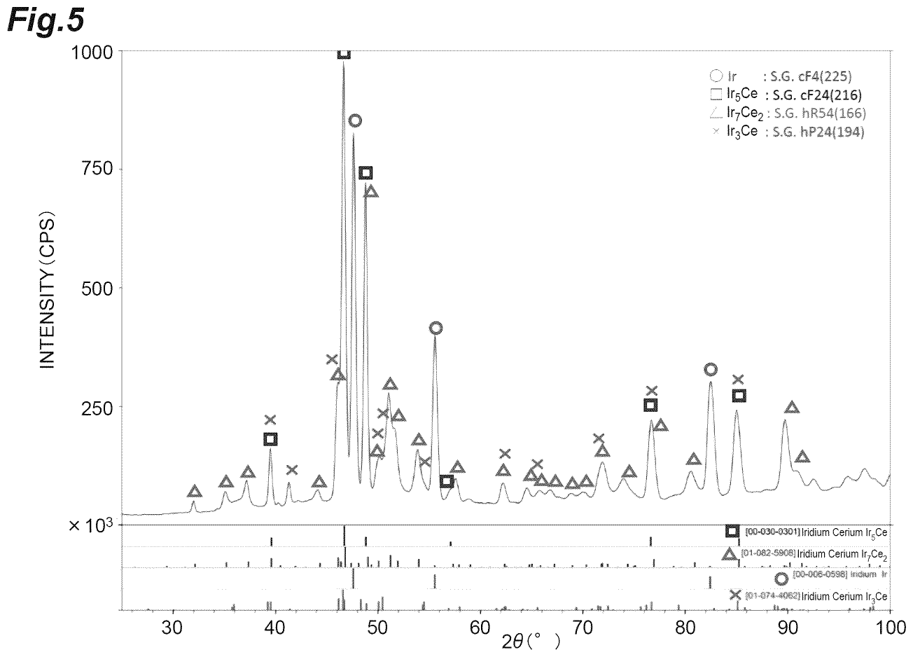

The sintered body used in Comparative Example 1 (sintered body constituted by an Ir₇Ce₂ crystal phase, manufactured by KOBELCO research institute) was heated at 1750° C. for 3 hours in air reduced to 10⁻⁵ Pa (oxygen partial pressure: about 2 ×10⁻⁶ Pa) to obtain a sintered material. FIG. 4 is a SEM image of the surface of the obtained sintered material. FIG. 5 is an XRD spectrum of the surface of the obtained sintered material. The first peak positioned at a scattering angle 2θ of 47.6° had a half-value width of 0.415, and the second peak positioned at a scattering angle 2θ of 55.5° had a half-value width of 0.489. The work function of the obtained sintered material was 3.67 eV. In addition, the iridium content was 82.8 parts by mass and the cerium content was 17.2 parts by mass with respect to 100 parts by mass of the total mass of the obtained sintered material.

### Example 2

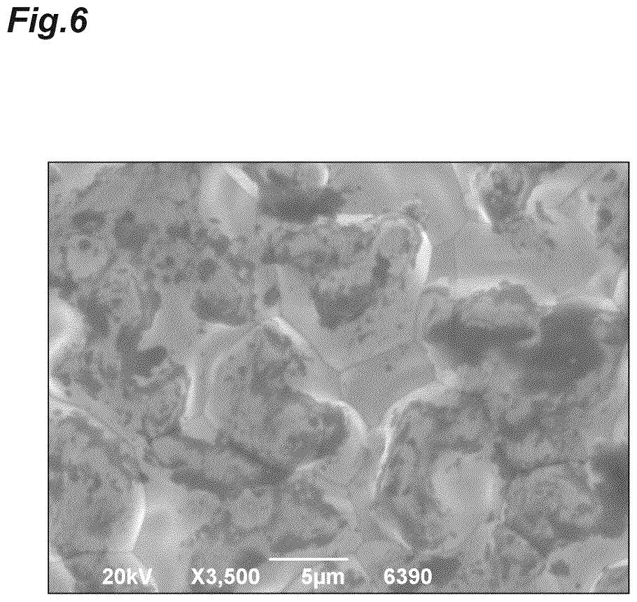

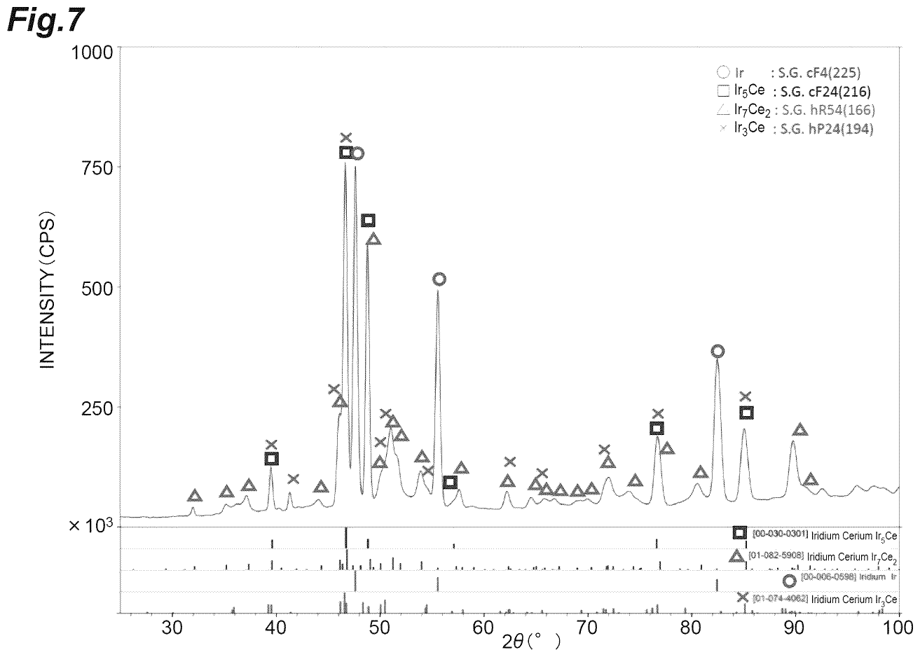

The sintered body used in Comparative Example 1 (sintered body constituted by an Ir₇Ce₂ crystal phase, manufactured by KOBELCO research institute) was heated at 1600° C. for 80 hours in air reduced to 10⁻⁵ Pa to obtain a sintered material. FIG. 6 is a SEM image of the surface of the obtained sintered material. FIG. 7 is an XRD spectrum of the surface of the obtained sintered material. The first peak positioned at a scattering angle 2θ of 47.6° had a half-value width of 0.429, and the second peak positioned at a scattering angle 2θ of 55.5° had a half-value width of 0.457. The work function of the obtained sintered material was 3.52 eV. In addition, the iridium content was 82.8 parts by mass and the cerium content was 17.2 parts by mass with respect to 100 parts by mass of the total mass of the obtained sintered material.

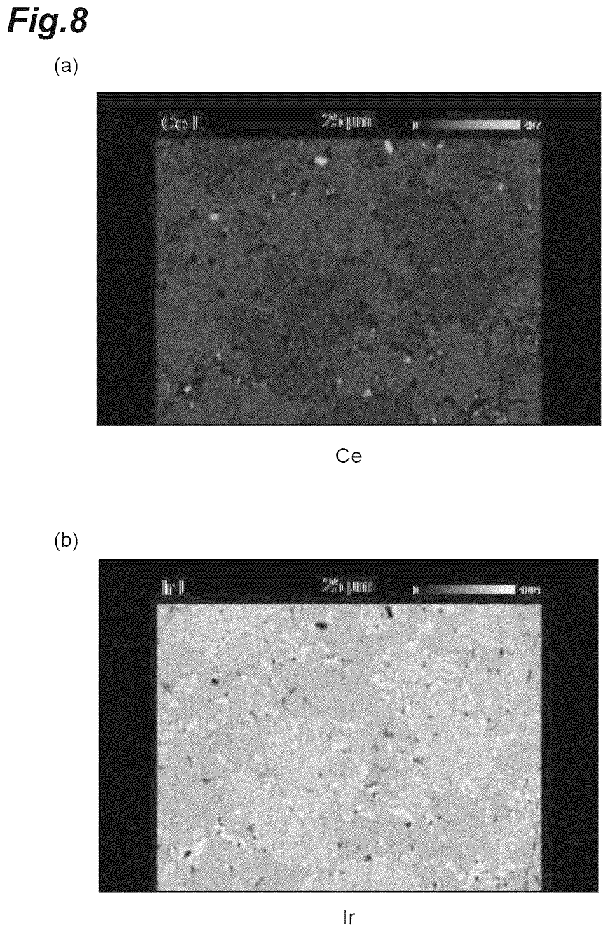

FIGS. 8(a) and 8(b) are images showing the results of EDX mapping analysis of the surface of the sintered body according to Comparative Example 1. FIG. 8(a) is an image showing the distribution state of the Ce element, and FIG. 8(b) is an image showing the distribution state of the Ir element. From these images, it can be seen that the Ce element and the Ir element are relatively uniformly distributed on the surface of the sintered body of Comparative Example 1.

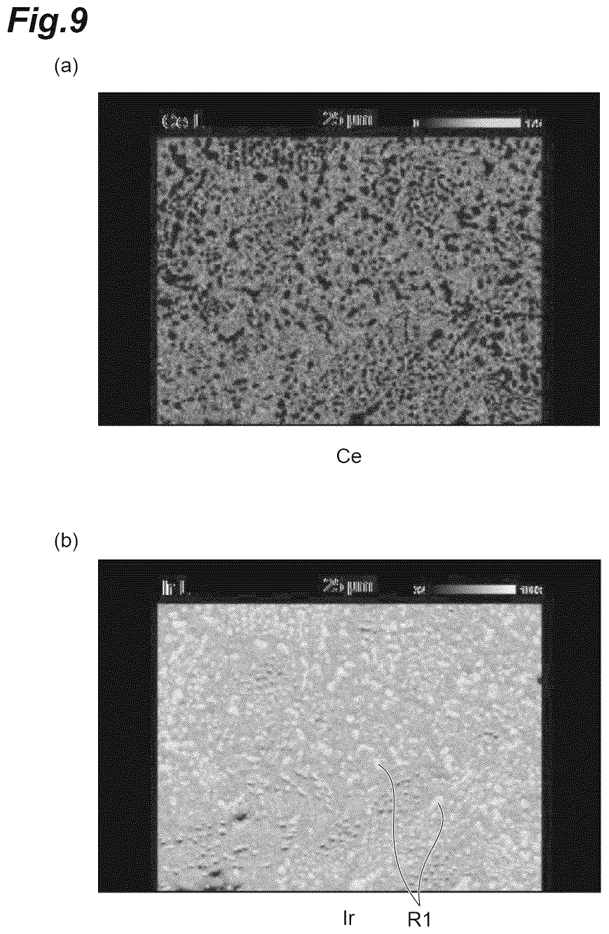

FIGS. 9(a) and 9(b) are images showing the results of EDX mapping analysis of the surface of the sintered material obtained in Example 1. FIG. 9(a) is an image showing the distribution state of the Ce element, and FIG. 9(b) is an image showing the distribution state of the Ir element. From these images, it can be seen that iridium regions RI (bright regions in FIG. 9(b)) are interspersed on the surface of the sintered material obtained in Example 1.

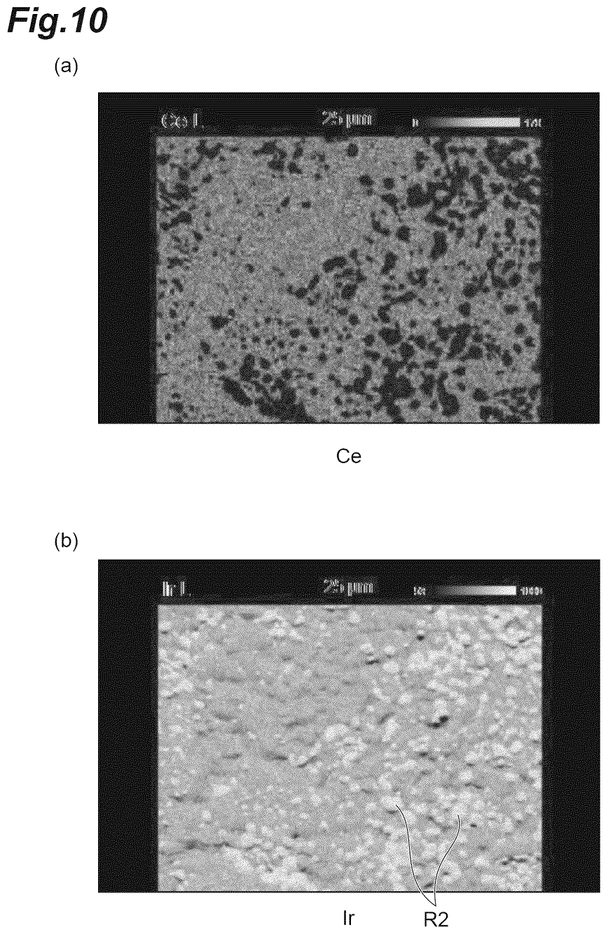

FIGS. 10(a) and 10(b) are images showing the results of EDX mapping analysis of the surface of the sintered material obtained in Example 2. FIG. 10(a) is an image showing the distribution state of the Ce element, and FIG. 10(b) is an image showing the distribution state of the Ir element. From these images, it can be seen that iridium regions R2 (bright regions in FIG. 10(b)) are interspersed on the surface of the sintered material obtained in Example 2.

It appears that the iridium regions R1 in the sintered material of Example 1 were relatively uniformly dispersed, whereas the iridium regions R2 in the sintered material of Example 2 were unevenly distributed. In addition, it appears that the iridium regions R2 in the sintered material of Example 2 were larger in size than the iridium regions R1 in the sintered material of Example 1.

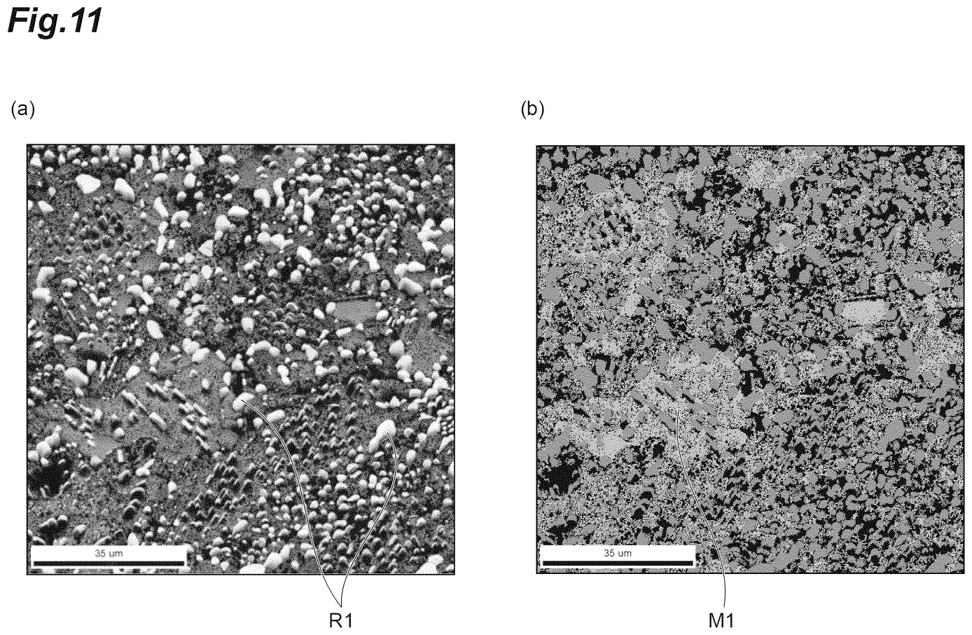

FIG. 11(a) and 11(b) are images showing the results of EBSD analysis of the surface of the sintered material obtained in Example 1. FIG. 11(a) is an IQ (image quality) map of the surface of the sintered material obtained in Example 1, and FIG. 11(b) is an image showing the distribution state of the Ir element and the Ir₇Ce₂ crystal phase on the surface of the sintered material obtained in Example 1. From these images, it can be seen that Example 1 includes a main body MI(bright region in FIG. 11(b)) constituted by the Ir element and the Ir₇Ce₂ crystal phase, and iridium regions R1(bright region in FIG. 11(a)) dispersed in an island manner on the surface of the main body MI. It is presumed that the iridium regions R1 are mainly constituted by the iridium element.

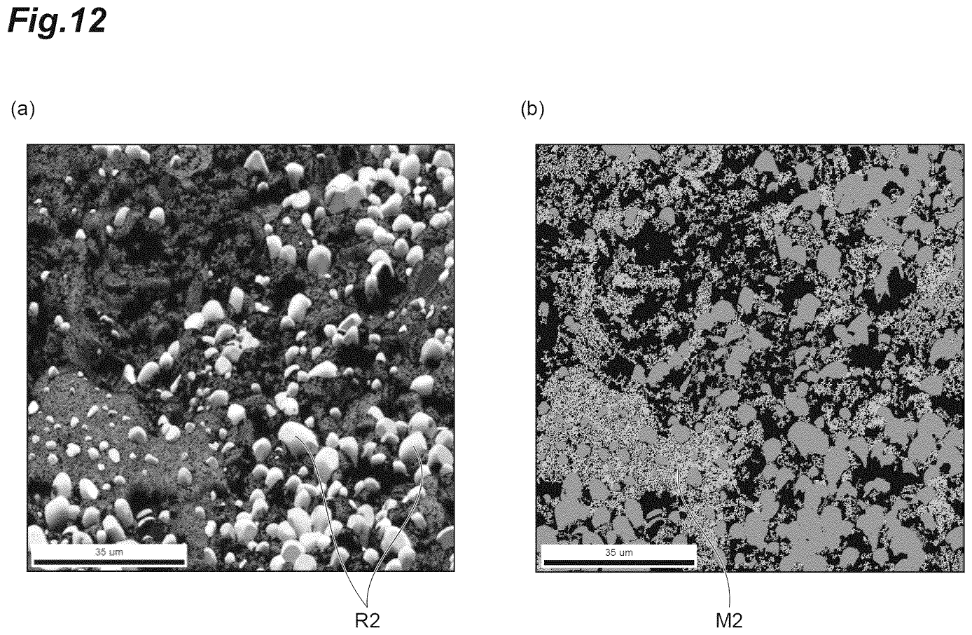

FIG. 12(a) and 12(b) are images showing the results of EBSD analysis of the surface of the sintered material obtained in Example 2. FIG. 12(a) is an IQ map of the surface in Example 2, and FIG. 12(b) is an image showing the distribution state of the Ir element and the Ir₇Ce₂ crystal phase on the surface in Example 2. From these images, it can be seen that the sintered material obtained in Example 2 includes a main body M2 bright (region in FIG. 12(b)) constituted by the Ir element and the Ir₇Ce₂ crystal phase, and iridium regions R2 (bright region in FIG. 12(a)) dispersed in an island manner on the surface of the main body M2. It is presumed that the iridium regions R2 are mainly constituted by the iridium element.

It appears that the iridium regions R1 in the sintered material of Example 1 were relatively uniformly dispersed on the surface of the main body M₁, whereas the iridium regions R2 in the sintered material of Example 2 were unevenly distributed on the surface of the main body M2. In addition, it appears that the iridium regions R2 in the sintered material of Example 2 were larger in size than the iridium regions R1 in the sintered material of Example 1.

### Example 3

A sintered material was obtained in the same manner as in Example 1 except that the oxygen partial pressure during the heating was changed to 10⁻¹ Pa. The work function of the obtained sintered material was 3.8 eV or less.

The present disclosure relates to the following.
[1] A method for producing a sintered material, the sintered material being constituted by iridium and cerium, and the method including: a step of preparing a sintered body constituted by iridium and cerium; and a step of heating the sintered body at a temperature of 1400 to 1800° C. for 0.5 hours or more in an atmosphere having an oxygen partial pressure of 10⁻¹ Pa or less to obtain the sintered material.
[2] The method for producing a sintered material according to [1], wherein the sintered body is constituted by at least one crystal phase selected from the group consisting of an Ir₂Ce crystal phase, an Ir₃Ce crystal phase, an Ir₇Ce₂ crystal phase, and an Ir₅ Ce crystal phase.
[3] The method for producing a sintered material according to [1] or [2], wherein the sintered body has a work function of 4.1 to 4.3 eV.
[4] A sintered material constituted by iridium and cerium, having a work function of 3.8 eV or less.
[5] The sintered material according to [4], including: a main body constituted by iridium and cerium; and an iridium region formed on a surface of the main body.
[6] The sintered material according to [4] or [5], having a peak with a half-value width of 0.5 or less positioned at a scattering angle 2θ of 47.6° in a spectrum obtained by XRD analysis of a surface of the sintered material.
[7] sintered material according to any one of [4] to [6], having a peak with a half-value width of 0.5 or less positioned at a scattering angle 2θ of 55.5° in a spectrum obtained by XRD analysis of a surface of the sintered material.
[8] The sintered material according to any one of [4] to [7], wherein cerium is contained in an amount of 12.7 to 26.7 parts by mass with respect to 100 parts by mass in total mass of the sintered material.
[9] An electron source including the sintered material according to any one of [4] to [8].
[10] A device including the electron source according to [9].

### REFERENCE SIGNS LIST

1 Electron source
2 Filament
3 Joint portion
M1, M2 Main body
R1, R2 Iridium region

1. A method for producing a sintered material, the sintered material being constituted by iridium and cerium, and the method comprising:
a step of preparing a sintered body constituted by iridium and cerium; and
a step of heating the sintered body at a temperature of 1400 to 1800° C. for 0.5 hours or more in an atmosphere having an oxygen partial pressure of 10⁻¹ Pa or less to obtain the sintered material.

2. The method for producing a sintered material according to claim 1, wherein the sintered body is constituted by at least one crystal phase selected from the group consisting of an Ir₂Ce crystal phase, an Ir₃Ce crystal phase, an Ir₇Ce₂ crystal phase, and an Ir₃Ce crystal phase.

3. The method for producing a sintered material according to claim 1, wherein the sintered body has a work function of 4.1 to 4.3 eV.

4. A sintered material constituted by iridium and cerium, having a work function of 3.8 eV or less.

5. The sintered material according to claim 4, comprising:
a main body constituted by iridium and cerium; and
an iridium region formed on a surface of the main body.

6. The sintered material according to claim 4, having a peak with a half-value width of 0.5 or less positioned at a scattering angle 2θ of 47.6° in a spectrum obtained by XRD analysis of a surface of the sintered material.

7. The sintered material according to claim 4, having a peak with a half-value width of 0.5 or less positioned at a scattering angle 2θ of 55.5° in a spectrum obtained by XRD analysis of a surface of the sintered material.

8. The sintered material according to claim 4, wherein cerium is contained in an amount of 12.7 to 26.7 parts by mass with respect to 100 parts by mass in total mass of the sintered material.

9. An electron source comprising the sintered material according to claim 4.

10. A device comprising the electron source according to claim 9.
